(19) United States
(12) Patent Application Publication
(10) Pub. No.: US 2015/0351585 A1
(43) Pub. Date: Dec. 10, 2015

(54) HINGED GRILL TOP

(71) Applicant: HARRY BLACKHURST, LOGANVILLE, GA (US)

(72) Inventor: HARRY BLACKHURST, LOGANVILLE, GA (US)

(21) Appl. No.: 14/734,721

(22) Filed: Jun. 9, 2015

Related U.S. Application Data
(60) Provisional application No. 62/009,452, filed on Jun. 9, 2014.

(51) Int. Cl. A47J 37/07; A47J 37/06

(52) U.S. Cl. CPC A47J 37/0704; A47J 37/0682

(57) ABSTRACT

A grill system for a kettle pit that includes: a frame, where the frame covers a bottom portion of the kettle pit; a grill surface, where the grill surface extends over the frame and includes a first half and a second half; a rod extending through the diameter of the frame and grill surface, where the rod divides the first half and second half of the grill surface; and hinges on the grill, where the hinges enable autonomous movement of the first half and the second half. The grill system further includes a first handle is provided for the first half and a second handle is provided for the second half. The frame preferably includes an outer rim and a plurality of crossbars.

### CROSS REFERENCE TO OTHER APPLICATIONS

This application claims priority to U.S. Provisional Application Ser. No. 62/009,452 filed on Jun. 9, 2014.

### BACKGROUND OF THE INVENTION

1. Field of Invention

The present invention relates to a hinged grill system for a kettle-style barbeque grill.

2. Description of Related Art

Outdoor grilling on a charcoal kettle grill is a common pastime or activity enjoyed by many individuals. Normally the kettle grill includes a dome top and domed bottom with the grill positioned over the domed bottom. Underneath the grill, charcoal is used as the heat source. This grill surface usually comprises one composite grill, which covers the entire opening of the kettle. Individuals usually use handles to remove the grill and place it over the charcoal. This charcoal underneath the grill occasionally needs to be adjusted during the grilling process. Many times individuals need to shift the charcoal, add charcoal or remove charcoal. The conventional grill top makes it difficult to adjust the charcoal while grilling due to the necessity that the entire grill must be removed. As a result it would be advantageous if the grill were modified in a manner that makes access to the underlying charcoal easier. Such convertible grill tops have been disclosed in prior art. In one particular disclosure, U.S. Pat. No. 8,511,295 a circular grill grate with a plurality of hinged grate sections is disclosed. Further U.S. Patent Application No. 2011/0270949 discloses a grill grate, which has that arm hinged for lifting and therefore advantageous in the addition, removal and reorganizing underlying charcoal.

### SUMMARY OF THE INVENTION

The present invention relates to a grill system for a kettle pit comprising: a frame, where the frame covers a bottom portion of the kettle pit; a grill surface, where the grill surface extends over the frame and includes a first half and a second half; a rod extending through the diameter of the frame and grill surface, where the rod divides the first half and second half of the grill surface; and hinges on the grill, where the hinges enable autonomous movement of the first half and the second half The grill system further includes a first handle is provided for the first half and a second handle is provided for the second half The frame preferably includes an outer rim and a plurality of crossbars.

### BRIEF DESCRIPTION OF DRAWINGS

FIG. 1 depicts a top view of a charcoal grill in accordance with the present invention.

FIG. 2 depicts the charcoal grill in accordance with the present invention, where each half is shown in a lifted position.

FIG. 3 depicts a cross section of the charcoal grill in accordance with the present invention.

FIG. 4 depicts a frame used in accordance with the charcoal grill in accordance with the present invention.

### DETAILED DESCRIPTION

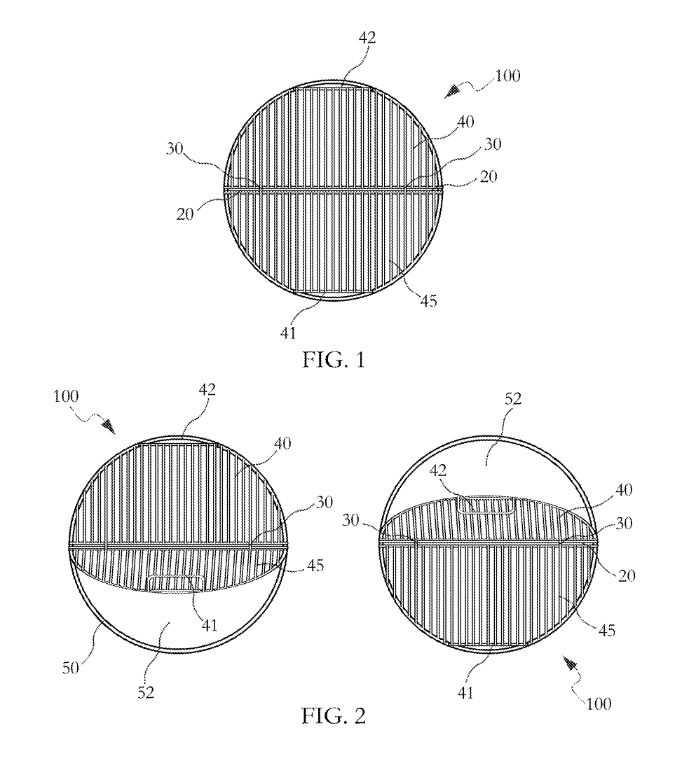

With respect to the present invention, FIG. 1 depicts a top view of the present invention as stated provides a hand-style grill for use on a kettle-style barbeque pit. This grill hinges across the diameter of the circular grill. The hinge allows for an individual to lift one side of the grill or 50 percent of the grill in an open position while the remaining portion of the grill remains in a flat position over the charcoal. The grill according to the present invention includes a rod that extends through the diameter of the grill and hinges that enable the turning of the grill about the rod to access and facilitate the movement of the charcoal. The grill rests upon a frame that secures each half of the grill in position so that the grill may be lifted as needed.

FIG. 1 depicts a top surface of the grill in accordance with the present invention. The grill 100 includes a first half 40 and a second half 45. Each half of the grill includes a handle 41, 42 for each respective portion of the grill 100. A center rod 20 extends across the diameter of the grill and provides the means to hinge each half of the grill that enables the separate lifting of each half as needed. Hinges 30 are provided along the length of the center rod 20. The hinges 30 allow the rotating movement of the grill as shown in FIG. 2. FIG. 2 shows the first half 40 in an open position in one figure and the second half 45 in an open position in the accompanying figure. Either open half 40, 45 provides ready access to the kettle opening 52, which contains charcoal during operation.

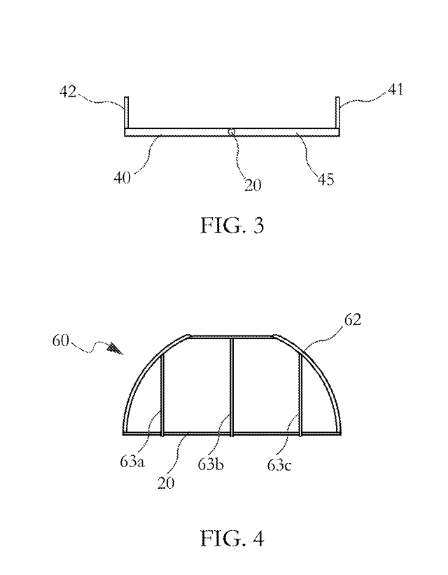

FIG. 3 depicts a cross-sectional view of the grill 100 in accordance with the present invention. In this cross-sectional view, handles 41, 42 are shown on each side of the grill and further each grill half 40, 45 are also shown. The rod 20 as shown travels through the center of the grill 100 separating each half 40, 45 that fit into a bottom frame 60, shown in FIG. 4, for the grill. The bottom frame enables the grill to sit within the frame and enables the movement of the grill as necessary.

FIG. 4 depicts reverse side of the frame 60. Frame 60 includes an outer rim 62 and crossbars 63A, 63B, 63C that extend from the rod 20. This frame is shown without the grill inserted and therefore gives a better view of the underside of the frame. The instant invention has been shown and described in what it considers to be the most practical and preferred embodiments. It is recognized, however, that departures may be made there from within the scope of the invention and that obvious modifications will occur to a person skilled in the art.

What is claimed is:

1. A grill system for a kettle pit comprising:
a. a frame, where the frame covers a bottom portion of the kettle pit;
b. a grill surface, where the grill surface extends over the frame and includes a first half and a second half;
c. a rod extending through the diameter of the frame and grill surface, where the rod divides the first half and second half of the grill surface; and
d. hinges on the grill, where the hinges enable autonomous movement of the first half and the second half.

2. The grill system according to claim 1, where a first handle is provided for the first half and a second handle is provided for the second half.

3. The grill system according to claim 1, where the frame includes an outer rim and a plurality of crossbars.
